(19) United States
(12) Patent Application Publication
(10) Pub. No.: US 2021/0126759 A1
(43) Pub. Date: Apr. 29, 2021

(54) METHOD AND DEVICE FOR TRANSMISSION AND SETTING TRANSMISSION, BASE STATION, TERMINAL AND STORAGE MEDIUM

(71) Applicant: ZTE CORPORATION, Shenzhen, Guangdong (CN)

(72) Inventors: Yijian CHEN, Shenzhen, Guangdong (CN); Zhaohua LU, Shenzhen, Guangdong (CN); YuNgok LI, Shenzhen, Guangdong (CN); Hao WU, Shenzhen, Guangdong (CN)

(21) Appl. No.: 16/497,319

(22) PCT Filed: Mar. 23, 2018
(86) PCT No.: PCT/CN2018/080363

§ 371 Date: Sep. 24, 2019

(30) Foreign Application Priority Data
Mar. 24, 2017 (CN) 201710184903.3

(51) Int. Cl. H04L 5/00

(52) U.S. Cl. CPC H04L 5/0078; H04L 5/0048

(57) ABSTRACT

The present disclosure provides a method and device for transmission and setting transmission, a base station, a terminal and a storage medium. The method includes: determining a transmission parameter set corresponding to a transmission resource region by a sending terminal, wherein transmission parameters in the transmission parameter set includes at least one of a resource aggregation granularity parameter, a precoding granularity parameter, and a resource mapping parameter; and executing transmission by the sending terminal in a corresponding transmission resource region according to the transmission parameters.

### CROSS-REFERENCE TO RELATED APPLICATIONS

The present application is based upon and claims priority to Chinese Patent Application No. 201710184903.3, filed on Mar. 24, 2017, the entire contents of which are incorporated herein by reference.

### TECHNICAL FIELD

The present disclosure relates to the field of communication, and in particular, to a method and device for transmission and setting transmission, a base station, a terminal and a storage medium.

### BACKGROUND

For a 4G (4^{th} Generation) long term evolution (LTE), some settings related to transmission may either be predetermined during the transmission between a sending terminal and a receiving terminal, or have a small variable range, which is not flexible. This method has a low complexity, but its performance is relatively poor. In addition, although this method may be suitable for some mainstream transmission scenarios in 4G, it restricts improvements of the performance in terms of a 5G (5^{th} Generation) new radio (NR) system. In the 5G NR, there is a great deal of transmission scenarios that require different transmission modes and bring various types of services. Thus, the existing transmission settings are not flexible enough to meet the needs of the 5G NR, for examples as follows.

Precoding binding parameters are parameters primarily used to define granularity of resources that adopt the same or associated precoding. During the transmission, a preferable method is to configure a demodulation reference signal (DMRS) to adopt the same precoding with the data, so that the data and the channel may undergo a same channel and thereby enable the transmission to be transparent. A beam weight known as the precoding is transparent to a terminal. On different time-frequency resources, since channels are not always the same, the precoding with a very small granularity can be adopted theoretically if the channel information is accurate enough. For example, a physical resource block (PRB) adopts one precoding, and different PRBs adopt different precoding. Theoretically, the smaller the granularity, the greater the precoding gains, and the more diversity gains in open loop transmission. However, the DMRSs on different PRBs cannot execute estimation jointly because of the different precoding, thus, the channel estimation performance of the DMRS may be damaged if the precoding granularity during the transmission is too small.

In an existing LTE system, if there is feedback from a precoding matrix indicator (PMI), the feedback granularity cannot be set too small due to overhead, and the precoding granularity is greater than one PRB and based on a physical resource block group (PRBG) level. The number of PRBs included in one PRBG is shown in Table 1, and is associated with system bandwidth. If there is no feedback from the PMI, the system is more likely a time division duplexing (TDD) system that has better reciprocity and can obtain channel information in a resource block (RB) level, which is more accurate. Therefore, precoding in the RB level is adopted, and the precoding granularity is one RB.

TABLE 1

| System Bandwidth | Precoding Binding Granularity |
|---|---|
| (N_{RB}^{DL}) | (P′) (PRBs) |
| ≤10 | 1 |
| 11-26 | 2 |
| 27-63 | 3 |
| 64-110 | 2 |

The related art has following problems: the precoding granularity setting is some predetermined values, and is not flexible; the precoding granularity merely depends on the bandwidth, and cannot be well adapted to various transmission situations; and the precoding granularity cannot be changed dynamically in the time domain.

Similar to the precoding binding parameters, resource aggregation parameters have the same problems. The resource aggregation herein mainly indicates size of the resource allocated for the uplink or the downlink.

For channel-to-resource mapping parameters, in a traditional technology, signals are mapped to resources by simply mapping in a sequence of spatial domain, frequency domain, and time domain. This technology has two major technical defects in the 5G NR.

The first defect is as follows. Since the amount of data transmitted in the NR is many times that of the existing 4G system, transmission blocks (TBs) encoded by low density parity check codes (LDPCs) are rather large, while each code block (CB) can only support a maximum of 8192 bits, thus, it may be divided into a plurality of CBs that are encoded independently. In order to obtain the diversity gains, information in the same CB shall undergo multiple different transmissions, and it is possible to support dozens of CBs if the bandwidth is large enough. However, if mapped in sequence as in related art, a CB may be only mapped to some subcarriers of a certain symbol, which may fail to fully obtain the diversity gains and thereby affect the performance.

The second defect is as follows. Since an ultra reliable and low latency communication (URLLC) service that the NR needs to support requires a very low transmission latency, the waiting time of the URLLC service in the queue shall also be short. Thus, in the downlink, the URLLC service shall be scheduled as soon as possible while arriving at a base station; and similarly, in the uplink, the URLLC service shall also be sent out from a terminal as soon as possible. If employing a frequency division multiplexing method for an enhanced mobile broadband (eMBB) service and the URLLC service, one possible method is to reserve sufficient resources for the URLLC service. However, since the URLLC service has a relatively low transmission frequency but requires an extremely high reliability, a large number of frequency resources need to be reserved if the scheduling interval is short. Therefore, the method of reserving resources may cause a great waste of the resources, and thereby is not a good solution for the NR network supporting the URLLC service. When the base station is transmitting the eMBB downlink service, another effective method is to allow the URLLC service to puncture the eMBB service that is already being transmitted, as shown in FIG. 1, so as to support multiplexing of the URLLC service and the eMBB service. If the eMBB service is punctured by the URLLC service, and the eMBB terminal fail to identify the data that are covered by the URLLC data among the received data, the eMBB terminal may directly decode all the received data, which may rapidly decrease the performance. In addition, if the data covered by the URRLC belong to a same CB, the CB cannot be correctly transmitted and shall be retransmitted, which may also affect the performance.

There is still no effective solution so far for solving the problem that settings related to the transmission have a low flexibility in related art.

### SUMMARY

The embodiments of the present disclosure provide a method and device for transmission and setting transmission, a base station, and a terminal, in order to at least solve the problem that settings related to the transmission have a low flexibility in related art.

In an embodiment of the present disclosure, there is provided a method for transmission, including: determining, by a sending terminal, a transmission parameter set corresponding to a transmission resource region, wherein transmission parameters in the transmission parameter set include at least one of a resource aggregation granularity parameter, a precoding granularity parameter, and a resource mapping parameter; and executing, by the sending terminal, transmission in a corresponding transmission resource region according to the transmission parameters.

In the aforesaid solution, the method further includes: determining, by the sending terminal, the transmission resource region, wherein transmission resources include at least one of a time domain resource, a frequency domain resource, an antenna resource, a beam resource, and a code resource, a quantity of the transmission resource region is N, and N is greater than or equal to 1.

In the aforesaid solution, the method includes: sending, by the sending terminal, a setting signaling of transmission to a receiving terminal.

In the aforesaid solution, the resource aggregation granularity parameter/precoding binding parameter is set respectively by one or more of: at least two downlink control information (DCI) types, at least two DCI overhead sizes, at least two transmission technologies, at least two pilot port groups, at least two channels/signals, at least two CB/code block groups (CBGs), at least two TBs/code words (CWs), at least two service types, at least two waveforms, at least two beam types, at least two beam groups, at least two time domain symbol groups/slot groups/subframe groups, at least two antennas, at least two modulation and coding schemes (MCSs), at least two resource mapping methods, at least two receiving methods, and at least two hybrid automatic repeat request (HARQ) related parameters.

In the aforesaid solution, the resource aggregation granularity parameter/precoding granularity parameter includes at least one time window parameter, wherein the time window parameter is used to determine a resource aggregation granularity/precoding binding granularity.

In the aforesaid solution, setting the time window parameter includes: setting the time window parameter for at least two types of channels/signals, respectively; or setting the time window parameter for at least two beam groups, respectively; or setting the time window parameter for at least two transmission resource regions, respectively.

In the aforesaid solution, an information-to-resource mapping setting is determined respectively by at least one of: at least two layers, at least two layer numbers, at least two CWs, at least two MCSs, at least two DMRS settings, at least two phase tracking reference signal (PTRS) settings, at least two numerology settings, at least two waveforms, at least two slot types, at least two transmission schemes, at least two DCI types, at least two traffic types, at least two CB/CBG settings, at least two transmission settings, at least two beams, at least two beam numbers, at least two receiving methods, at least two precoding binding granularities/resource aggregation granularities, at least two HARQ related parameters, and at least two multiple access methods/multiplexing methods.

In the aforesaid solution, setting the precoding binding granularity includes: dynamically setting the precoding binding granularity with signaling of the DCI.

In another embodiment of the present disclosure, there is provided a method for setting transmission, including: determining, by a receiving terminal, a transmission resource region, wherein transmission resources include a time domain resource, a frequency domain resource, an antenna resource, a beam resource, and a code resource; and determining, by the receiving terminal, a transmission parameter set corresponding to the transmission resource region, wherein transmission parameters in the transmission parameter set include at least one of a resource aggregation granularity parameter, a precoding granularity parameter, a resource mapping parameter, and a CB/CBG.

In the aforesaid solution, the method further includes: executing, by the receiving terminal, transmission in the transmission resource region according to the transmission parameter set.

In the aforesaid solution, the resource aggregation granularity parameter/precoding binding parameter is determined respectively by one or more of: a DCI type, a transmission technology, a pilot port group, a channel/signal type, a CB/CBG setting, a service type, a waveform, a beam type, a beam group, a time domain symbol group/slot group/subframe group, an antenna group, an MCS group, a resource allocation granularity, a pilot pattern, an antenna/port number, an HARQ related parameter, a receiving method, a multiple access method, a multiplexing method, and a quasi-co-location (QCL) setting.

In the aforesaid solution, the receiving terminal determines a precoding granularity parameter of a second channel/signal according to a precoding granularity parameter of a first channel/signal; the receiving terminal determines a precoding granularity parameter of uplink data/DMRS according to a precoding granularity parameter of a sounding reference signal (SRS) and a precoding granularity parameter of uplink control; the receiving terminal determines a precoding granularity parameter of uplink control/DMRS according to the precoding granularity parameter of SRS and a precoding granularity parameter of uplink data; and the receiving terminal determines a precoding granularity parameter of downlink data/downlink control/DMRS according to a precoding granularity parameter of a channel state information-reference signal (CSI-RS).

In the aforesaid solution, the receiving terminal determines a precoding granularity parameter of an uplink channel/signal according to a precoding granularity parameter of a downlink channel/signal; the receiving terminal determines a precoding granularity parameter of SRS according to a precoding granularity parameter of CSI-RS; and the receiving terminal determines a precoding granularity parameter of uplink (UL) DMRS according to a precoding granularity parameter of CSI-RS.

In the aforesaid solution, the receiving terminal determines a precoding granularity parameter of a downlink channel/signal according to a precoding granularity parameter of an uplink channel/signal.

In the aforesaid solution, a multiple relationship occurs between binding granularities of at least two channels/signals, and a multiple relationship occurs between precoding binding granularities of at least two pilot ports.

In the aforesaid solution, the resource aggregation granularity parameter/precoding granularity parameter includes at least one time window parameter, wherein the time window parameter is used to determine a resource aggregation granularity/precoding binding granularity.

In the aforesaid solution, determining the time window parameter includes: determining the time window parameter according to a type of a transmission channel/signal; or determining the time window parameter according to a beam group to which the transmission belongs; or determining the time window parameter according to the transmission resource region.

In the aforesaid solution, an information-to-resource mapping setting is determined respectively by at least one of: a layer/layer group, a layer number, a MCS, a DMRS pattern, a PTRS pattern, a numerology, a waveform, a slot type, a transmission scheme, a DCI type, a traffic type, a CB/CBG setting, a transmission setting, a beam, a beam number, a receiving method, a precoding binding granularity/resource aggregation granularity, an HARQ related parameter, a multiple access method, a multiplexing method, an A/N setting, a CW/TB setting, and a QCL setting.

In the aforesaid solution, a candidate set of the information-to-resource mapping setting includes at least a discrete CB/CBG mapping method and a centralized CB/CBG mapping method.

In another embodiment of the present disclosure, there is provided a device for transmission, applied at a sending terminal, including: a first determination module configured to determine a transmission parameter set corresponding to a transmission resource region, wherein transmission parameters in the transmission parameter set includes at least one of a resource aggregation granularity parameter, a precoding granularity parameter, and a resource mapping parameter; and a transmission module configured to execute transmission in a corresponding transmission resource region according to the transmission parameters.

In the aforesaid solution, the device further includes: a module configured to determine the transmission resource region, wherein transmission resources include at least one of a time domain resource, a frequency domain resource, an antenna resource, a beam resource, and a code resource, a quantity of the transmission resource region is N, and N is greater than or equal to 1.

In the aforesaid solution, the device further includes: a module configured to send a setting signaling of transmission to a receiving terminal.

In the aforesaid solution, the resource aggregation granularity parameter/precoding binding parameter is set respectively by one or more of: at least two DCI types, at least two DCI overhead sizes, at least two transmission technologies, at least two pilot port groups, at least two channels/signals, at least two CB/CBGs, at least two TBs/CWs, at least two service types, at least two waveforms, at least two beam types, at least two beam groups, at least two time domain symbol groups/slot groups/subframe groups, at least two antennas, at least two MCSs, at least two resource mapping methods, and at least two HARQ related parameters.

In the aforesaid solution, the resource aggregation granularity parameter/precoding granularity parameter includes at least one time window parameter, wherein the time window parameter is used to determine a resource aggregation granularity/precoding binding granularity.

In the aforesaid solution, setting the time window parameter includes: setting the time window parameter for at least two types of channels/signals, respectively; or setting the time window parameter for at least two beam groups, respectively; or setting the time window parameter for at least two transmission resource regions, respectively.

In the aforesaid solution, an information-to-resource mapping setting is determined respectively by at least one of: at least two layers, at least two layer numbers, at least two CWs, at least two MCSs, at least two DMRS settings, at least two PTRS settings, at least two numerology settings, at least two waveforms, at least two slot types, at least two transmission schemes, at least two DCI types, at least two traffic types, at least two CB/CBG settings, at least two transmission settings, at least two beams, at least two beam numbers, at least two receiving methods, at least two precoding binding granularities/resource aggregation granularities, at least two HARQ related parameters, and at least two multiple access methods/multiplexing methods.

In the aforesaid solution, the transmission parameters further include setting information of CB/CBG, and a terminal may determine settings of the CB and CBG according to following information: a capability of a receiving node, a setting of layer numbers, a DCI type, a transmission technology, a demodulation reference signal setting, a resource allocation granularity, a multiple access method, a multiplexing method, an MCS setting, and a QCL setting.

In another embodiment of the present disclosure, there is provided a device for transmission, applied at a receiving terminal, including: a second determination module configured to determine a transmission resource region, wherein transmission resources include a time domain resource, a frequency domain resource, an antenna resource, a beam resource, and a code resource; and a third determination module configured to determine a transmission parameter set corresponding to the transmission resource region, wherein transmission parameters in the transmission parameter set includes at least one of a resource aggregation granularity parameter, a precoding granularity parameter, a resource mapping parameter, and a CB/CBG.

In the aforesaid solution, the device further includes a module configured to execute transmission in the transmission resource region according to the transmission parameter set.

In the aforesaid solution, the resource aggregation granularity parameter/precoding binding parameter is determined respectively by one or more of: a DCI type, a transmission technology, a pilot port group, a channel/signal type, a CB/CBG setting, a service type, a waveform, a beam type, a beam group, a time domain symbol group/slot group/subframe group, an antenna group, an MCS group, a resource allocation granularity, a pilot pattern, an antenna/port number, an HARQ related parameter, a receiving method, a multiple access method, a multiplexing method, and a QCL setting.

In the aforesaid solution, the device determines a precoding granularity parameter of a second channel/signal according to a precoding granularity parameter of a first channel/signal; the device determines a precoding granularity parameter of uplink data/DMRS according to a precoding granularity parameter of SRS and a precoding granularity parameter of uplink control; the device determines a precoding granularity parameter of uplink control/DMRS according to the precoding granularity parameter of SRS and a precoding granularity parameter of uplink data; and the device determines a precoding granularity parameter of downlink data/downlink control/DMRS according to a precoding granularity parameter of CSI-RS.

In the aforesaid solution, the device determines a precoding granularity parameter of an uplink channel/signal according to a precoding granularity parameter of a downlink channel/signal; the device determines a precoding granularity parameter of SRS according to a precoding granularity parameter of CSI-RS; and the device determines a precoding granularity parameter of UL DMRS according to the precoding granularity parameter of CSI-RS.

In the aforesaid solution, the device determines a precoding granularity parameter of a downlink channel/signal according to a precoding granularity parameter of an uplink channel/signal.

In the aforesaid solution, a multiple relationship occurs between binding granularities of at least two channels/signals, and a multiple relationship occurs between precoding binding granularities of at least two pilot ports.

In the aforesaid solution, the resource aggregation granularity parameter/precoding granularity parameter includes at least one time window parameter, wherein the time window parameter is used to determine a resource aggregation granularity/precoding binding granularity.

In the aforesaid solution, determining the time window parameter includes: determining the time window parameter according to a type of a transmission channel/signal; or determining the time window parameter according to a beam group to which the transmission belongs; or determining the time window parameter according to the transmission resource region.

In the aforesaid solution, an information-to-resource mapping setting is determined respectively by at least one of: a layer/layer group, a layer number, a MCS, a DMRS pattern, a PTRS pattern, a numerology, a waveform, a slot type, a transmission scheme, a DCI type, a traffic type, a CB/CBG setting, a transmission setting, a beam, a beam number, a receiving method, a precoding binding granularity/resource aggregation granularity, an HARQ related parameter, a multiple access method, a multiplexing method, an A/N setting, a CW/TB setting, and a QCL setting.

In the aforesaid solution, a candidate set of the information-to-resource mapping setting includes at least a discrete CB/CBG mapping method and a centralized CB/CBG mapping method.

In another embodiment of the present disclosure, there is provided a base station, including: a processor and a memory storing instructions executable to the processor, which, when executing the instructions, implements steps of: determining a transmission parameter set corresponding to a transmission resource region, wherein transmission parameters in the transmission parameter set include at least one of a resource aggregation granularity parameter, a precoding granularity parameter, and a resource mapping parameter; and executing transmission in a corresponding transmission resource region according to the transmission parameters.

In the aforesaid solution, the resource aggregation granularity parameter/precoding binding parameter is set respectively by one or more of: at least two DCI types, at least two DCI overhead sizes, at least two transmission technologies, at least two pilot port groups, at least two channels/signals, at least two CB/CBGs, at least two TBs/CWs, at least two service types, at least two waveforms, at least two beam types, at least two beam groups, at least two time domain symbol groups/slot groups/subframe groups, at least two antennas, at least two MCSs, at least two resource mapping methods, and at least two HARQ related parameters.

In another embodiment of the present disclosure, there is provided a terminal, including: a processor and a memory storing instructions executable to the processor, which, when executing the instructions, implements steps of: determining a transmission resource region, wherein transmission resources include a time domain resource, a frequency domain resource, an antenna resource, a beam resource, and a code resource; and determining a transmission parameter set corresponding to the transmission resource region, wherein transmission parameters in the transmission parameter set include at least one of a resource aggregation granularity parameter, a precoding granularity parameter, a resource mapping parameter, and a CB/CBG.

In the aforesaid solution, the resource aggregation granularity parameter/precoding binding parameter is determined respectively by one or more of: a DCI type, a transmission technology, a pilot port group, a channel/signal type, a CB/CBG setting, a service type, a waveform, a beam type, a beam group, a time domain symbol group/slot group/subframe group, an antenna group, an MCS group, a resource allocation granularity, a pilot pattern, an antenna/port number, an HARQ related parameter, a receiving method, a multiple access method, a multiplexing method, and a QCL setting.

In another embodiment of the present disclosure, there is provided a storage medium. The storage medium is configured to store program codes for implementing steps of: determining, by a sending terminal, a transmission parameter set corresponding to a transmission resource region, wherein transmission parameters in the transmission parameter set include at least one of a resource aggregation granularity parameter, a precoding granularity parameter, and a resource mapping parameter; and executing, by the sending terminal, transmission in a corresponding transmission resource region according to the transmission parameters.

In the aforesaid solution, the storage medium is further configured to store program codes for implementing steps of: determining, by a receiving terminal, a transmission resource region, wherein transmission resources include a time domain resource, a frequency domain resource, an antenna resource, a beam resource, and a code resource; and determining, by the receiving terminal, a transmission parameter set corresponding to the transmission resource region, wherein transmission parameters in the transmission parameter set include at least one of a resource aggregation granularity parameter, a precoding granularity parameter, a resource mapping parameter, and a CB/CBG.

The embodiments of the present disclosure further provides a storage medium in which computer-executable instructions are stored, wherein the computer-executable instructions are used to execute the method for setting transmission.

In the present disclosure, the sending terminal determines a transmission parameter set corresponding to a transmission resource region, wherein transmission parameters in the transmission parameter set include at least one of a resource aggregation granularity parameter, a precoding granularity parameter, and a resource mapping parameter; and the sending terminal then executes transmission in a corresponding transmission resource region according to the transmission parameters, so that the sending terminal may set the transmission parameters more flexibly, which thereby solves the problem that settings related to the transmission have a low flexibility in related art.

### BRIEF DESCRIPTION OF THE DRAWINGS

Here, the accompanying drawings are illustrated to provide further understanding of the present disclosure, which constitute a part of the specification. The exemplary embodiments of the present disclosure and the description are used to explain the present disclosure, and do not constitute improper limit to the present disclosure. In the accompanying drawings:

FIG. 1 is a schematic diagram of a method for transmission in related art;

FIG. 2 is a flowchart of a method for transmission according to an embodiment of the present disclosure;

FIG. 3 is a schematic diagram of a method for transmission according to an embodiment of the present disclosure;

FIG. 4 is a first schematic diagram of a method for transmission according to an embodiment of the present disclosure;

FIG. 5 is a second schematic diagram of a method for transmission according to an embodiment of the present disclosure;

FIG. 6 is a structural block diagram of a device for transmission according to an embodiment of the present disclosure;

FIG. 7 is a flowchart of a method for setting transmission according to an embodiment of the present disclosure;

FIG. 8 is a first schematic diagram of a primary type of a resource mapping setting according to an embodiment of the present disclosure;

FIG. 9 is a second schematic diagram of a primary type of a resource mapping setting according to an embodiment of the present disclosure; and

FIG. 10 is a structural block diagram of a device for setting transmission according to an embodiment of the present disclosure.

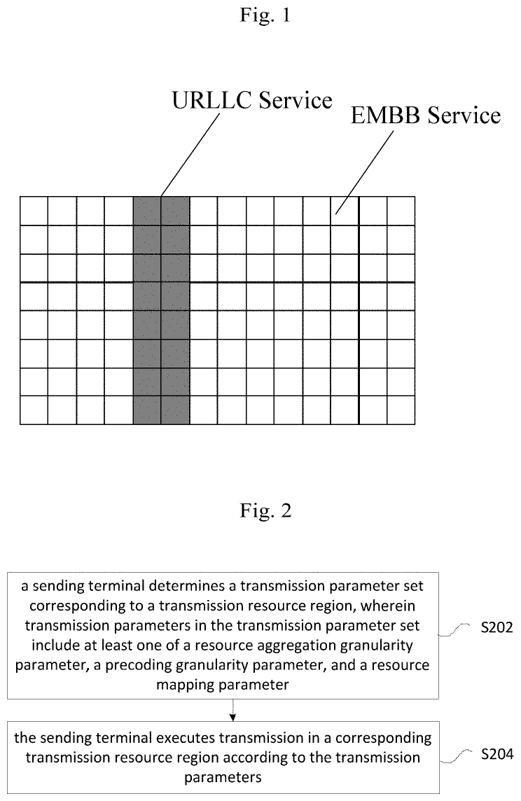

### DETAILED DESCRIPTION

The present disclosure will be described in detail below with reference to the accompanying drawings and embodiments. It should be noted that the embodiments of the present disclosure and features of the embodiments may be combined with each other in any manner as long as they are not contradictory.

It is to be noted that terms “first”, “second”, and the like used in Description, Claims and the accompanying drawings are used for the purpose of distinguishing similar objects instead of indicating a particular order or sequence.

### Embodiment 1

In this embodiment, there is provided a method for transmission. FIG. 2 is a flowchart of the method for transmission according to an embodiment of the present disclosure. As shown in FIG. 2, the flow includes steps of S202 to S204.

In step S202, a sending terminal determines a transmission parameter set corresponding to a transmission resource region, and transmission parameters in the transmission parameter set include at least one of a resource aggregation granularity parameter, a precoding granularity parameter, and a resource mapping parameter.

In step S204, the sending terminal executes transmission in a corresponding transmission resource region according to the transmission parameters.

In the aforesaid solution, the sending terminal in this embodiment includes, but is not limited to, a base station.

Through the aforesaid steps, the sending terminal determines a transmission parameter set corresponding to a transmission resource region, and transmission parameters in the transmission parameter set include at least one of a resource aggregation granularity parameter, a precoding granularity parameter, and a resource mapping parameter. The sending terminal then executes transmission in a corresponding transmission resource region according to the transmission parameters, so that the sending terminal may set the transmission parameters more flexibly, which thereby solves the problem that settings related to the transmission have a low flexibility in related art.

In an embodiment of the aforesaid solution, the method further includes that the sending terminal determines the transmission resource region, and transmission resources include at least one of a time domain resource, a frequency domain resource, an antenna resource, a beam resource, and a code resource, a quantity of the transmission resource region is N, and N is greater than or equal to 1.

In the aforesaid solution, the sending terminal sends a setting signaling of transmission to a receiving terminal.

In this embodiment, the resource aggregation granularity parameter/precoding binding parameter is set respectively by one or more of: at least two DCI types, at least two DCI overhead sizes, at least two transmission technologies, at least two pilot port groups, at least two channels/signals, at least two CB/CBGs, at least two TBs/CWs, at least two service types, at least two waveforms, at least two beam types, at least two beam groups, at least two time domain symbol groups/slot groups/subframe groups, at least two antennas, at least two MCSs, at least two resource mapping methods, and at least two HARQ related parameters.

The resource aggregation granularity parameter/precoding granularity parameter includes at least one time window parameter, and the time window parameter is used to determine a resource aggregation granularity/precoding binding granularity. Setting the time window parameter includes: setting the time window parameter for at least two types of channels/signals, respectively; or setting the time window parameter for at least two beam groups, respectively; or setting the time window parameter for at least two transmission resource regions, respectively.

In the aforesaid solution, an information-to-resource mapping setting may be determined respectively by at least one of: at least two layers, at least two layer numbers, at least two CWs, at least two MCSs, at least two DMRS settings, at least two PTRS settings, at least two numerology settings, at least two waveforms, at least two slot types, at least two transmission schemes, at least two DCI types, at least two traffic types, at least two CB/CBG settings, at least two transmission settings, at least two beams, at least two beam numbers, at least two receiving methods, at least two precoding binding granularities/resource aggregation granularities, at least two HARQ related parameters, and at least two multiple access methods/multiplexing methods.

This embodiment will be exemplified below with reference to specific examples.

### Optional Embodiment 1

The base station sets the resource aggregation granularity parameter/precoding binding parameter for at least two DCI types, as shown in Table 2.

TABLE 2

| | Aggregation granularity/precoding |
|---|---|
| DCI type | binding parameter setting |
| DCI format 1, 2 | Signaling a1 |
| DCI format 3, 4 | Signaling b1 |

The resource aggregation granularity parameter/precoding binding parameter is set for at least two DCI overhead sizes, respectively, as shown in Table 3.

TABLE 3

| | Aggregation granularity/precoding |
|---|---|
| DCI type | binding parameter setting |
| DCI size 1 | Signaling a2 |
| DCI size 2 | Signaling b2 |

The resource aggregation granularity parameter/precoding binding parameter is set for at least two transmission technologies, respectively, as shown in Table 4.

TABLE 4

| | Aggregation granularity/precoding |
|---|---|
| Transmission Technology | binding parameter setting |
| Open loop transmission/ | Signaling a3 |
| semi-open loop transmission | |
| Closed loop transmission | Signaling b3 |

The resource aggregation granularity parameter/precoding binding parameter is set for at least two pilot port groups, respectively, as shown in Table 5.

TABLE 5

| DMRS/SRS/CSI-RS | Aggregation granularity/precoding |
|---|---|
| port group | binding parameter setting |
| Port group 1 | Signaling a4 |
| Port group 2 | Signaling b4 |

The resource aggregation granularity parameter/precoding binding parameter is set for at least two types of channels/signals, respectively, as shown in Table 6.

TABLE 6

| | Aggregation granularity/precoding |
|---|---|
| Channel/signal type | binding parameter setting |
| SRS | Signaling a5 |
| DMRS | Signaling b5 |
| CSI-RS | Signaling c5 |
| Data Channel | Signaling a6 |
| Control channel | Signaling b6 |

The resource aggregation granularity parameter/precoding binding parameter is set for at least two CB/CBGs, respectively.

The CB identifies a plurality of independent code blocks in the transmission block, and the CBG identifies a group composed of code blocks, as shown in Table 7.

TABLE 7

| | Aggregation granularity/precoding |
|---|---|
| CB/CBG Index | binding parameter setting |
| CB1/CBG1 | Signaling a7 |
| CB2/CBG2 | Signaling b7 |

It may also be as shown in Table 8.

TABLE 8

| | Aggregation granularity/precoding |
|---|---|
| CB/CBG setting | binding parameter setting |
| CB setting 1/CBG | Signaling a7 |
| setting 2 | |
| CB setting 2/CBG | Signaling b7 |
| setting 2 | |

In other words, if the settings for partitioning the current TB into CBs/CBGs are changed, the aggregate granularity parameter/precoding binding parameter may be different.

The resource aggregation granularity parameter/precoding binding parameter is set for at least two TBs/CWs, respectively, where TB indicates a transmission block, and the CW denotes the codeword, which are generally considered as a same concept, as shown in Table 9.

TABLE 9

| | Aggregation granularity/precoding |
|---|---|
| TB/CW | binding parameter setting |
| TB1/CW1 | Signaling a8 |
| TB2/CW2 | Signaling b8 |

The resource aggregation granularity parameter/precoding binding parameter is set for at least two service types, respectively, as shown in Table 10.

TABLE 10

| | Aggregation granularity/precoding |
|---|---|
| Service Type | binding parameter setting |
| URLLC service | Signaling a9 |
| eMBB service | Signaling b9 |

The resource aggregation granularity parameter/precoding binding parameter is set for at least two waveforms, respectively, as shown in Table 11.

TABLE 11

| | Aggregation granularity/precoding |
|---|---|
| Channel/signal type | binding parameter setting |
| URLLC service | Signaling a10 |
| eMBB service | Signaling b10 |

The resource aggregation granularity parameter/precoding binding parameter is set for at least two beam types, respectively, as shown in Table 12.

TABLE 12

| | Aggregation granularity/precoding |
|---|---|
| Beam type | binding parameter setting |
| Beam type 1 | Signaling a11 |
| Beam type 2 | Signaling b11 |

The resource aggregation granularity parameter/precoding binding parameter is set for at least two beam groups, respectively, as shown in Table 13.

TABLE 13

| | Aggregation granularity/precoding |
|---|---|
| Beam index | binding setting |
| Beam index 1 | Signaling a12 |
| Beam index 2 | Signaling b12 |

The resource aggregation granularity parameter/precoding binding parameter is set for at least two time domain symbol groups/slot groups/subframe groups, respectively, as shown in Table 14.

TABLE 14

| Time domain symbol | |
|---|---|
| group/slot group/ | Aggregation granularity/precoding |
| subframe group index | binding setting |
| Time domain symbol | Signaling a13 |
| group/slot group/ | |
| subframe group 1 | |
| Time domain symbol | Signaling b13 |
| group/slot group/ | |
| subframe group 2 | |

The resource aggregation granularity parameter/precoding binding parameter is set for at least two antennas, respectively, as shown in Table 15.

TABLE 15

| | Aggregation granularity/precoding |
|---|---|
| Antenna index | binding setting |
| Antenna 1 | Signaling a14 |
| Antenna 2 | Signaling b14 |

The resource aggregation granularity parameter/precoding binding parameter is set for at least two MCSs, respectively, as shown in Table 16.

TABLE 16

| | Aggregation granularity/precoding |
|---|---|
| MCS type | binding setting |
| QPSK 1/3 code rate | Signaling a15 |
| 16QAM 1/2 code rate | Signaling b15 |
| 64QAM 3/4 code rate | Signaling c15 |

The resource aggregation granularity parameter/precoding binding parameter is set for at least two resource mapping methods, respectively, as shown in Table 17.

TABLE 17

| | Aggregation granularity/precoding |
|---|---|
| Resource mapping method | binding setting |
| Discrete method | Signaling a16 |
| Centralized method | Signaling b16 |

The resource aggregation granularity parameter/precoding binding parameter is set for at least two receiving methods, respectively, as shown in Table 18.

TABLE 18

| | Aggregation granularity/precoding |
|---|---|
| Receiving method | binding setting |
| Receiving method 1 | Signaling a17 |
| Receiving method 2 | Signaling b17 |

The resource aggregation granularity parameter/precoding binding parameter is determined for at least the HARQ related parameters (such as, new/old data status, redundancy version number, etc.), respectively, as shown in Tables 19-21.

TABLE 19

| | Aggregation granularity/precoding |
|---|---|
| HARQ process number | binding setting |
| 1 | Signaling a18 |
| 2 | Signaling b18 |

TABLE 20

| Retransmission | |
|---|---|
| redundancy | Aggregation granularity/precoding |
| version number | binding setting |
| 1 | Signaling a19 |
| 3 | Signaling b19 |

TABLE 21

| New/old data | Aggregation granularity/precoding |
|---|---|
| status | binding setting |
| New data | Signaling a20 |
| Retransmission | Signaling b20 |
| data | |

### Optional Embodiment 2

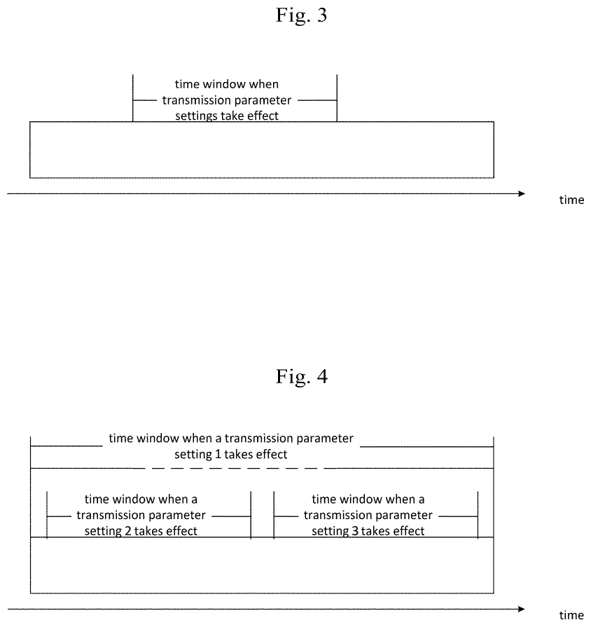

The resource aggregation granularity parameter/precoding granularity parameter includes at least one time window parameter. As shown in FIG. 3, the time window is used to determine a resource aggregation granularity/precoding binding granularity.

There may be several methods for determining the time window. The methods for determining the start time may include following methods.

Method 1: specifying the start time position when executing the setting.

Method 2: setting the time when the predetermined event occurs as the start time.

Method 3: setting the time with an offset value relative to the time when the predetermined event occurs as the start time.

The predetermined event may be preferably defined as receiving setting signaling, or a first transmission after receiving the setting signaling.

The methods for determining the end time may include following methods.

Method 1: setting the end time position of the signaling.

Method 2: setting the time when the predetermined event occurs as the end time.

Method 3: setting the time with an offset value relative to the time when the predetermined event occurs as the end time.

The predetermined event may be preferably defined as receiving a signaling indicating the end.

The predetermined event may be preferably defined as receiving a signaling indicating re-setting.

There is also a situation as shown in FIG. 4.

Transmission parameter setting 1 is a default setting. When a transmission parameter setting 2 is set, the transmission setting 2 takes effect during its active time. When a transmission parameter setting 3 is set, the transmission setting 3 takes effect during its active time. At other times, the transmission parameter setting 1 takes effect. There may still be a situation where the transmission parameter setting 1 is combined with the transmission parameter setting 2 for determining the final setting when the transmission parameter setting 2 is set, and a situation where the transmission parameter setting 1 is combined with the transmission parameter setting 3 for determining the final setting when the transmission parameter setting 3 is set.

The sending terminal sets the time window parameter for a plurality of different channels/signals.

The sending terminal sets the time window parameters for a plurality of different beam groups.

The sending terminal sets the time window parameters for a plurality of different frequency domain transmission resource regions.

### Optional Embodiment 3

The sending terminal may determine the information-to-resource mapping setting for at least two layers, respectively. For example, mapping methods for transmission in layer 1 and transmission in layer 2 are set respectively.

The sending terminal may determine the information-to-resource mapping setting for at least two layer numbers, respectively. For example, mapping methods for transmission of 2 layers and transmission of 4 layers are set respectively.

The sending terminal may determine the information-to-resource mapping setting for at least two CWs, respectively. For example, mapping methods for transmission of CW 1 and transmission of CW 2 are set respectively.

The sending terminal may determine the information-to-resource mapping setting for at least two MCSs, respectively. For example, mapping methods for transmission of MCS 1 and transmission of MCS 2 are set respectively.

The sending terminal may determine the information-to-resource mapping setting for at least two DMRSs, respectively. For example, mapping methods for data transmission or control information transmission corresponding to a DMRS pattern 1 and a DMRS pattern 2 are set respectively; mapping methods for data transmission or control information transmission corresponding to DMRS port number 2 and DMRS port number 4 are set respectively; and mapping methods for data transmission or control information transmission corresponding to DMRS OCC=2 and DMRS OCC=4 are set respectively.

The sending terminal may determine the information-to-resource mapping setting for at least two PTRS settings. The settings herein include parameters such as location, density, number of ports, enabling status and the like.

The sending terminal may determine the information-to-resource mapping setting for at least two numerology settings. Numerology parameters herein include CP length, subcarrier density, subcarrier spacing, symbol length, and FFT points.

The sending terminal may determine the information-to-resource mapping setting for at least two waveforms, respectively. For example, the resource mapping settings for CP-OFDM and SC-FDMA are determined respectively.

The sending terminal may determine the information-to-resource mapping setting for at least two slot types, respectively.

The sending terminal may determine the information-to-resource mapping setting for at least two transmission schemes, respectively.

The sending terminal may determine the information-to-resource mapping setting for at least two DCI types, respectively.

The sending terminal may determine the information-to-resource mapping setting for at least two traffic type, respectively.

The sending terminal may determine the information-to-resource mapping setting for at least two CB/CBG settings, respectively.

The sending terminal may determine the information-to-resource mapping setting for at least two transmission settings, respectively.

The sending terminal may determine the information-to-resource mapping setting for at least two beams, respectively.

The sending terminal may determine the information-to-resource mapping setting for at least two beam numbers, respectively.

The sending terminal may determine the information-to-resource mapping setting for at least two receiving methods, respectively.

The sending terminal may determine the information-to-resource mapping setting for at least two precoding binding granularities/resource aggregation granularities, respectively.

The sending terminal may determine the information-to-resource mapping setting for at least HARQ related parameters (such as, new/old data status, redundancy version number, etc.), respectively.

The sending terminal may determine the information-to-resource mapping setting for at least two multiple access methods/multiplexing methods, respectively.

### Optional Embodiment 4

In 5G, since the supported operating frequency range spans a lot and there is a plurality of application scenarios, the differentiation in features of the channel may be greater than that in 4G. In addition, in multi-beam systems, settings of radio frequency beamwidth may be different, and thus, the corresponding channel frequency selection may have different sizes. Therefore, it seems no longer a suitable method to determine the precoding binding granularity based only on the size of the bandwidth and whether there is PMI feedback. The flexibility of the setting shall be enhanced, and the need for the enhancement may potentially come from the following aspects.

Aspect a, for the closed loop transmission of control channels and data channels, the used transmitting and receiving beams are not necessarily the same. The control channels may use wider beams for transmission and reception, whereas the data channels may use narrower beams. Since the number of effective multipaths in the wide beam range differs from that in the narrow beam range, the corresponding frequency selection may be different. A more flexible precoding binding granularity setting may bring a better performance.

Aspect b, the transmitting or receiving beam used by the downlink data channel or control channel may change over time. On one hand, changes may take place to the width of the beams. The beams may become narrower and narrower with the beam training. On the other hand, even if the width of the beams remains the same, the influences from multipath delay and TAE to the beams in different directions are different. The base station may pre-set different precoding binding granularities for different transmitting/receiving beam or beampair links (BPLs).

Aspect c, when the downlink data is transmitted with a plurality of beams and corresponds to different layers, the channel corresponding to each transmission layer may have different frequency selections. These layers may be set with different PRB sizes.

Aspect d, for the open loop transmission or semi-open loop transmission, the base station may set the precoding binding granularity having different sizes, which means different diversity gains. In a situation where a large number of frequency domain resources are allocated, the precoding binding granularities having a larger size may be used. While, in a situation where a relatively small number of frequency domain resources are allocated, the precoding binding granularities having a smaller size shall be set to obtain sufficient diversity gains. The most appropriate precoding binding granularity may vary with different resource allocation situations.

Aspect e, for the multi-point coordinative transmission, if the transmitting node is dynamically switched, significant changes may frequently take place to the corresponding channel features. The difference in indication of settings of the quasi-co-location relationship may also cause changes to the precoding binding granularity. In addition, the dynamic node switching (DNS) greatly differs from the joint transmission (JT) in frequency selection. For the JT transmission, a large number of multipaths are added, and the delay of multipath from different transmission nodes (TN) may also have significant differences, so the frequency selection will be much larger.

Aspect f, the size of the CQI/MCS (channel quality indicator/modulation coding scheme) may reflect the size of the signal noise ratio (SNR) to a certain extent. For low SNRs, it is generally necessary to set precoding binding granularities having a larger size to ensure the estimation performance of the DMRS. For high SNRs, it is more important to improve the precoding transmission efficiency, and under this situation, precoding binding granularities having a relatively smaller size may be set.

### Optional Embodiment 5

There are two methods to implement the flexible precoding binding granularity setting.

Method 1: The base station may set the precoding binding granularity for multiple transmission hypotheses, respectively. For example, corresponding precoding binding granularities for multiple transmitting beams/receiving beams/BPLs are set respectively; corresponding precoding binding granularities for multiple transmission technologies are set respectively; corresponding precoding binding granularities for multiple resource allocation scenarios are set respectively, and so on. The terminal determines the corresponding precoding binding granularity according to the current transmission. If there is beam correspondence between the uplink and downlink, the precoding binding granularity of the uplink channels and that of the downlink channels may be jointly set, and the channels with the binding relationship have the same precoding binding granularity.

Method 2: The precoding binding granularity is dynamically set by signaling of the DCI to adapt to dynamic changes in the transmitting and receiving beams, allocated resources, MCSs and the like.

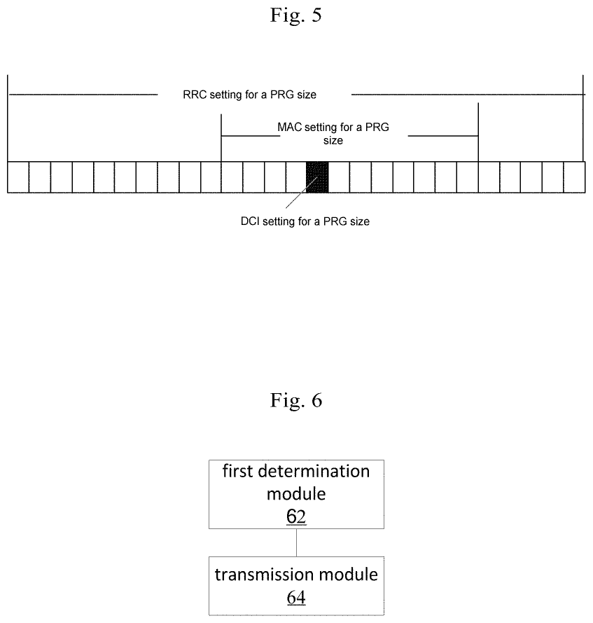

A setting method as shown in FIG. 5 includes that the base station sets a precoding binding granularity value set through RRC, and the MAC customer edge (CE) selects a subset from the set and activates the subset for a period of time. The DCI selects a precoding binding granularity (value) from the subset.

If there is only settings of the RRC signaling and DCI signaling but no valid MAC CE for indicating a size subset selection, a default method for selecting the subset shall be predetermined.

If there are only settings of the RRC signaling and valid MAC CE but no DCI signaling, a method for selecting the default value, such as the first value, from the size subset of the MAC CE setting shall be predetermined.

If there are only settings of the RRC signaling but no valid MAC CE settings or DCI indications, a method for determining the default value from the size set of the RRC setting shall be predetermined.

It should be noted that the precoding binding granularity subset selection may also be implemented by DCI besides the MAC CE settings.

### Optional Embodiment 6

The aforementioned precoding binding may be either for the sender or for the receiver.

The precoding bundling time window of the transmitting beams may be a subset of the precoding binding window of the receiving beams.

It should also be noted that, for the aforementioned transmitting and receiving beams, the transmitting beams may be characterized by a quasi-co-location relationship with other reference signals, and the receiving beams may be characterized by a correlation with spatial features of other reference signals. Transmitting/receiving beams is a specific manner for the transmission/reception.

### Optional Embodiment 7

The transmission parameter information may further include setting information of CB/CBG, and the terminal may determine settings of the CB and CBG according to following information, which includes: a capability of a receiving node, a setting of layer numbers, a DCI type, a transmission technology, a demodulation reference signal setting, a resource allocation granularity, a multiple access method, a multiplexing method, an MCS setting, and a QCL setting.

Through the description of the above embodiment, those skilled in the art can clearly understand that the method according to the above embodiments may be implemented by means of software plus a necessary general hardware platform. Obviously, it may also be implemented by hardware. But in many cases, the former is a better method. Based on such understanding, the technical solutions provided in the present disclosure essentially or, in other words, a part thereof contributing to related art, can be embodied in a form of a software product, in which the software product is stored in a storage medium (such as an ROM/RAM, a disk, or an optical disc) and includes a number of instructions to make a terminal device (which may be a mobile phone, a computer, a server, or a network device, etc.) execute the devices of the embodiments of the present disclosure.

### Embodiment 2

In the embodiment, there is further provided a device for transmission, which is configured to implement the above embodiments, and repeated descriptions are omitted herein. The term “module” as used below may be a combination of software and/or hardware for implementing preset functions. The device described in the following embodiment may be preferably implemented in software, but hardware, or a combination of software and hardware, is also possible and conceivable.

FIG. 6 is a structural block diagram of a device for transmission according to an embodiment of the present disclosure. As shown in FIG. 6, the device includes a first determination module 62 and a transmission module 64.

The first determination module 62 is configured to determine a transmission parameter set corresponding to a transmission resource region, and transmission parameters in the transmission parameter set include at least one of a resource aggregation granularity parameter, a precoding granularity parameter, and a resource mapping parameter.

The transmission module 64 is configured to execute transmission in a corresponding transmission resource region according to the transmission parameters.

Due to the aforesaid device, the sending terminal may set the transmission parameter more flexibly, which solves the problem that the settings related to the transmission have a low flexibility in related art.

In the embodiment of the aforesaid solution, the resource aggregation granularity parameter/precoding binding parameter is set respectively by one or more of: at least two DCI types, at least two DCI overhead sizes, at least two transmission technologies, at least two pilot port groups, at least two channels/signals, at least two CB/CBGs, at least two TBs/CWs, at least two service types, at least two waveforms, at least two beam types, at least two beam groups, at least two time domain symbol groups/slot groups/subframe groups, at least two antennas, at least two MCSs, at least two resource mapping methods, and at least two HARQ related parameters.

### Embodiment 3

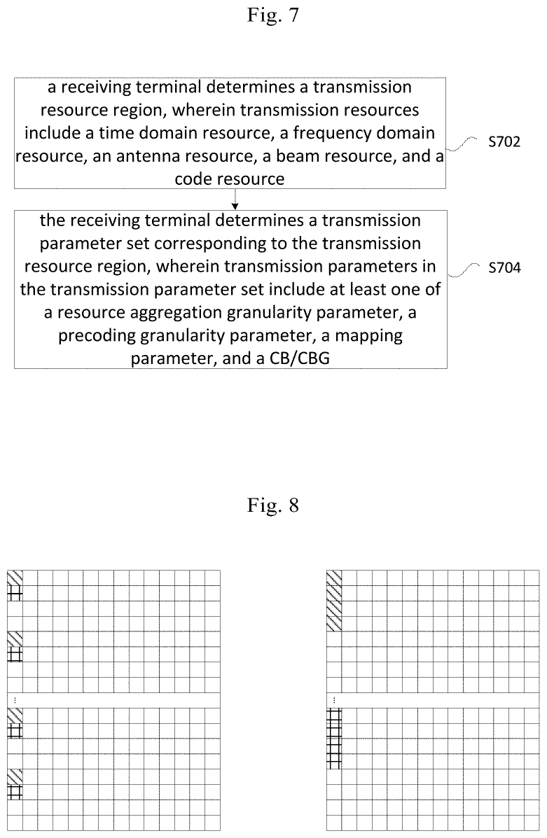

In the embodiment, there is further provided a method for setting transmission. FIG. 7 is a flowchart of the method for setting transmission according to an embodiment of the present disclosure. As shown in FIG. 7, the flow includes steps of S702 to S704.

In step S702, a receiving terminal determines a transmission resource region, and transmission resources include a time domain resource, a frequency domain resource, an antenna resource, a beam resource, and a code resource.

In step S704, the receiving terminal determines a transmission parameter set corresponding to the transmission resource region, and transmission parameters in the transmission parameter set include at least one of a resource aggregation granularity parameter, a precoding granularity parameter, a resource mapping parameter, and a CB/CBG.

Through the aforesaid steps, the receiving terminal determines a transmission resource region, and transmission resources include a time domain resource, a frequency domain resource, an antenna resource, a beam resource, and a code resource. The receiving terminal then determines a transmission parameter set corresponding to the transmission resource region, and transmission parameters in the transmission parameter set include at least one of a resource aggregation granularity parameter and a precoding granularity parameter, so that the receiving terminal may set the transmission parameters more flexibly, which thereby solves the problem that settings related to the transmission have a low flexibility in related art.

Through the aforesaid steps, the sending terminal determines a transmission parameter set corresponding to a transmission resource region, and transmission parameters in the transmission parameter set includes at least one of a resource aggregation granularity parameter, a precoding granularity parameter, and a resource mapping parameter. The sending terminal then executes transmission in a corresponding transmission resource region according to the transmission parameters, so that the sending terminal may set the transmission parameters more flexibly, which thereby solves the problem that settings related to the transmission have a low flexibility in related art.

In the embodiment of the aforesaid solution, the receiving terminal executes transmission in the transmission resource region according to the transmission parameter set.

In the aforesaid solution, the resource aggregation granularity parameter/precoding binding parameter is determined respectively by one or more of: a DCI type, a transmission technology, a pilot port group, a channel/signal type, a CB/CBG setting, a service type, a waveform, a beam type, a beam group, a time domain symbol group/slot group/subframe group, an antenna group, an MCS group, a resource allocation granularity, a pilot pattern, an antenna/port number, an HARQ related parameter, a receiving method, a multiple access method, a multiplexing method, and a QCL setting.

The receiving terminal determines a precoding granularity parameter of a second channel/signal according to a precoding granularity parameter of a first channel/signal; and the receiving terminal determines a precoding granularity parameter of uplink data/DMRS according to a precoding granularity parameter of SRS and a precoding granularity parameter of uplink control; the receiving terminal determines a precoding granularity parameter of uplink control/DMRS according to the precoding granularity parameter of SRS and a precoding granularity parameter of uplink data; and the receiving terminal determines a precoding granularity parameter of downlink data/downlink control/DMRS according to a precoding granularity parameter of CSI-RS.

In the aforesaid solution, the receiving terminal determines a precoding granularity parameter of an uplink channel/signal according to a precoding granularity parameter of a downlink channel/signal; the receiving terminal determines a precoding granularity parameter of SRS according to a precoding granularity parameter of CSI-RS; and the receiving terminal determines a precoding granularity parameter of UL DMRS according to the precoding granularity parameter of CSI-RS.

The receiving terminal determines a precoding granularity parameter of a downlink channel/signal according to a precoding granularity parameter of an uplink channel/signal.

In the aforesaid solution, and in the embodiment, a multiple relationship occurs between binding granularities of at least two channels/signals, and a multiple relationship occurs between precoding binding granularities of at least two pilot ports.

The resource aggregation granularity parameter/precoding granularity parameter includes at least one time window parameter, and the time window parameter is used to determine a resource aggregation granularity/precoding binding granularity.

Here, determining the time window parameter includes: determining the time window parameter according to a type of the transmission channel/signal; or determining the time window parameter according to a beam group to which the transmission belongs; or determining the time window parameter according to the transmission resource region.

The information-to-resource mapping setting may be determined respectively by at least one of: a layer/layer group, a layer number, an MCS, a DMRS pattern, a PTRS pattern, a numerology, a waveform, a slot type, a transmission scheme, a DCI type, a traffic type, a CB/CBG setting, a transmission setting, a beam, a beam number, a receiving method, a precoding binding granularity/resource aggregation granularity, an HARQ related parameter, a multiple access method, a multiplexing method, an A/N setting, a CW/TB setting, and a QCL setting.

A candidate set of mapping settings of the transmission resource region includes at least a discrete CB/CBG mapping method and a centralized CB/CBG mapping method.

The embodiment will be exemplified below with reference to specific examples.

### Optional Embodiment 8

The receiving terminal determines the resource aggregation granularity parameter/precoding binding parameter by one or more of: a DCI type; a transmission technology; a pilot port group; a channel/signal type; a CB/CBG setting; a service type; a waveform; a beam type; a beam group; a time domain symbol group/slot group/subframe group; an antenna group; an MCS group; a resource allocation granularity; a pilot pattern; an antenna/port number; an HARQ related parameter; a receiving method; a multiple access method; a multiplexing method; and a QCL setting.

In one situation, the sending terminal sets different resource aggregation granularity parameters/precoding binding parameters for the aforesaid different types of information. At this point, the receiving terminal needs to combine the state of the aforesaid types of information with the setting signaling to determine the current resource aggregation granularity parameter/precoding binding parameter.

In another situation, the sending terminal and the receiving terminal predetermine different resource aggregation granularity parameter/precoding binding parameter values for different states of the aforesaid types of information, so that the current resource aggregation granularity parameter/precoding binding parameter can be determined according to the current state of the aforesaid types of information.

### Optional Embodiment 9

The precoding binding granularities between different channels/signals are correlated, and the correlation preferably includes a functional relationship that may be a multiple relationship in particular. The precoding granularity of the first channel/signal is 1/2/4 times the precoding granularity of the second channel/signal, or the precoding granularity of the second channel/signal is 1/2/4 times the precoding granularity of the first channel/signal. The terminal determines the precoding granularity parameter of the second channel/signal according to the precoding granularity parameter of the first channel/signal.

For example, the terminal determines the precoding granularity parameter of uplink data/DMRS according to the precoding granularity parameter of SRS.

The terminal determines the precoding granularity parameter of uplink control/DMRS according to the precoding granularity parameter of SRS.

The terminal determines the precoding granularity of downlink data/DMRS according to CSI-RS.

The terminal determines the precoding granularity of downlink control/DMRS according to CSI-RS.

The terminal determines the precoding granularity parameter of uplink data/DMRS according to the precoding granularity parameter of uplink control.

The terminal determines the precoding granularity parameter of uplink control/DMRS according to the precoding granularity parameter of uplink data.

Preferably, the binding granularities of a plurality of channels or signals have a multiple relationship.

Preferably, the precoding binding granularities of a plurality of pilot ports have a multiple relationship.

### Optional Embodiment 10

The precoding binding granularity between the uplink transmission and the downlink transmission is correlated, and the correlation preferably includes a functional relationship. The functional relationship may be a multiple relationship in particular. The terminal determines a precoding granularity parameter of an uplink channel/signal according to a precoding granularity parameter of a downlink channel/signal.

The terminal determines a precoding granularity parameter of SRS according to a precoding granularity parameter of CSI-RS.

The terminal determines a precoding granularity parameter of UL DMRS according to a precoding granularity parameter of CSI-RS.

These types of uplink and downlink transmission channels/signals can be bound together for parameter determination.

### Optional Embodiment 11

The resource aggregation granularity parameter/precoding granularity parameter includes at least one time window parameter. The time window is used to determine a resource aggregation granularity/precoding binding granularity.

In an embodiment, the receiving terminal determines the time window parameter according to the type of the channel/signal of the transmission.

In an embodiment, the receiving terminal determines the time window parameter according to a beam group to which the transmission belongs.

In an embodiment, the receiving terminal determines the time window parameter according to the transmission resource region.

### Optional Embodiment 12

The receiving terminal determines the information-to-resource mapping setting for at least two receiving methods, respectively.

The receiving terminal may determine the information-to-resource mapping setting for at least two precoding binding granularities/resource aggregation granularities, respectively.

The receiving terminal may determine the information-to-resource mapping setting for at least HARQ related parameters (such as, process number, new/old data status, redundancy version number, etc.), respectively.

### Optional Embodiment 13

The receiving terminal determines the resource mapping setting by one or more of the flowing.

The information-to-resource mapping setting is determined according to layers or layer groups, respectively.

The information-to-resource mapping setting is determined according to layer numbers, respectively.

The information-to-resource mapping setting is determined according to MCSs, respectively.

The information-to-resource mapping setting is determined according to DMRS patterns, respectively.

The information-to-resource mapping setting is determined according to PTRS patterns, respectively.

The information-to-resource mapping setting is determined according to numerologies, respectively.

The information-to-resource mapping setting is determined according to waveforms, respectively.

The information-to-resource mapping setting is determined according to slot types, respectively.

The information-to-resource mapping setting is determined according to transmission schemes, respectively.

The information-to-resource mapping setting is determined according to DCI types, respectively.

The information-to-resource mapping setting is determined according to traffic types, respectively.

The information-to-resource mapping setting is determined according to CB/CBG settings, respectively.

The information-to-resource mapping setting is determined according to transmission settings, respectively.

The information-to-resource mapping setting is determined according to beams, respectively.

The information-to-resource mapping setting is determined according to beam numbers, respectively.

The information-to-resource mapping setting is determined according to receiving methods, respectively.

The information-to-resource mapping setting is determined according to precoding binding granularities/resource aggregation granularities, respectively.

The information-to-resource mapping setting is determined according to HARQ related parameters, respectively.

The information-to-resource mapping setting is determined according to multiple access methods or multiplexing methods, respectively.

The information-to-resource mapping setting is determined according to CW/TB settings, respectively.

The information-to-resource mapping setting is determined according to QCL settings, respectively.

### Optional Embodiment 14

As shown in FIG. 8, the resource mapping setting mainly include two types, a discrete CB mapping method and a centralized CB mapping method.

The shadow grids having the same type in FIG. 8 indicate some corresponding transmission symbols after interlacing and modulating a CB, or some corresponding transmission symbols after fully interlacing and modulating a CBG.

The resource mapping setting at least includes a discrete CB mapping method and a centralized CB mapping method.

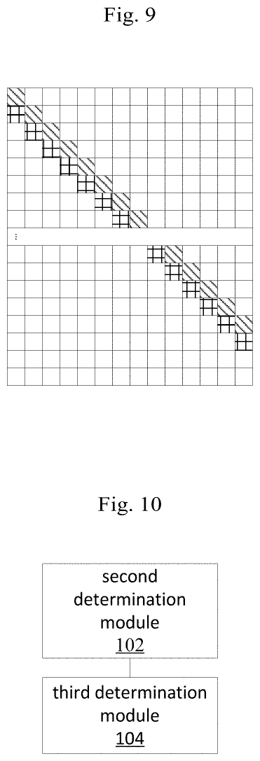

As shown in FIG. 9, the discrete method may also be performed at both time and frequency domains besides at the frequency domain.

It should be pointed out that both the centralized method and the discrete method actually contain a plurality of specific mapping methods. In general, the centralized transmission has small diversity gains but can realize interference coordination easily. The discrete method has large diversity gains, but hardly perform the interference coordination and can only realize interference randomization.

URLLC services may puncture some data in the symbol. Under this situation, if the quantity of A/N as set is relatively large, a centralized mapping method may be adopted and the CB or CBG is retransmitted to prevent from causing great influences. If the quantity of A/N as set is relatively small, a discrete mapping method may be adopted to spread the influence caused by puncturing the RE to different CBs, thereby correcting the error with the coding redundancy.

In addition, different mapping methods have different processing speeds. The processing speed of the discrete mapping method is relatively smaller, especially, in the time domain. The processing speed of the centralized mapping is greater. Therefore, the mapping method can be determined according to the service type.

Through the description of the above embodiment, those skilled in the art can clearly understand that the method according to the above embodiment may be implemented by means of software plus a necessary general hardware platform. Obviously, it may also be implemented by hardware. But in many cases, the former is a better method. Based on such understanding, the technical solutions provided in the present disclosure essentially or, in other words, a part thereof contributing to related art, can be embodied in a form of a software product, in which the software product is stored in a storage medium (such as an ROM/RAM, a disk, or an optical disc) and includes a number of instructions to make a terminal device (which may be a mobile phone, a computer, a server, or a network device, etc.) execute the devices of the embodiments of the present disclosure.

### Embodiment 4

In the embodiment, there is further provided a device for setting transmission, which is configured to implement the above embodiments, and repeated descriptions are omitted herein. The term “module” as used below may be a combination of software and/or hardware for implementing a preset functions. The device described in the following embodiment may be implemented in software, but hardware, or a combination of software and hardware, is also possible and conceivable.

FIG. 10 is a structural block diagram of the device for setting transmission according to an embodiment of the present disclosure. As shown in FIG. 10, the device includes a second determination module 102 and a third determination module 104.

The second determination module 102 is configured to determine a transmission resource region, and transmission resources include a time domain resource, a frequency domain resource, an antenna resource, a beam resource, and a code resource.

The third determination module 104 is configured to determine a transmission parameter set corresponding to the transmission resource region, and transmission parameters in the transmission parameter set include at least one of a resource aggregation granularity parameter, a precoding granularity parameter, a resource mapping parameter, and a CB/CBG.

Due to the aforesaid device, the receiving terminal may set the transmission parameters more flexibly, which solves the problem that settings related to the transmission have a low flexibility in related art.

In the embodiment of the aforesaid solution, the resource aggregation granularity parameter/precoding binding parameter is set respectively by one or more of: a DCI type, a transmission technology, a pilot port group, a channel/signal type, a CB/CBG setting, a service type, a waveform, a beam type, a beam group, a time domain symbol group/slot group/subframe group, an antenna group, an MCS group, a resource allocation granularity, a pilot pattern, an antenna/port number, an HARQ related parameter, a receiving method, a multiple access method, a multiplexing method, and a QCL setting.

### Embodiment 5

In an embodiment, there is provided a base station, including: a processor and a memory storing instructions executable to the processor, which, when executing the instructions, implements steps of: determining a transmission parameter set corresponding to a transmission resource region, wherein transmission parameters in the transmission parameter set include at least one of a resource aggregation granularity parameter, a precoding granularity parameter, and a resource mapping parameter; and executing the transmission in a corresponding transmission resource region according to the transmission parameters.

In an embodiment of the aforesaid solution, the resource aggregation granularity parameter/precoding binding parameter is set respectively by one or more of: at least two DCI types, at least two DCI overhead sizes, at least two transmission technologies, at least two pilot port groups, at least two channels/signals, at least two CB/CBGs, at least two TBs/CWs, at least two service types, at least two waveforms, at least two beam types, at least two beam groups, at least two time domain symbol groups/slot groups/subframe groups, at least two antennas, at least two MCSs, at least two resource mapping methods, and at least two HARQ related parameters.

### Embodiment 6

In an embodiment, there is provided a terminal, including: a processor and a memory storing instructions executable to the processor, which, when executing the instructions, implements steps of: determining a transmission resource region, wherein transmission resources include a time domain resource, a frequency domain resource, an antenna resource, a beam resource, and a code resource; and determining a transmission parameter set corresponding to the transmission resource region, wherein transmission parameters in the transmission parameter set include at least one of a resource aggregation granularity parameter, a precoding granularity parameter, a resource mapping parameter, and a CB/CBG.

In an embodiment of the aforesaid solution, the resource aggregation granularity parameter/precoding binding parameter is determined respectively by one or more of: a DCI type, a transmission technology, a pilot port group, a channel/signal type, a CB/CBG setting, a service type, a waveform, a beam type, a beam group, a time domain symbol group/slot group/subframe group, an antenna group, an MCS group, a resource allocation granularity, a pilot pattern, an antenna/port number, an HARQ related parameter, a reception method, a multiple access method, a multiplexing method, and a QCL setting.

### Embodiment 7

In an embodiment of the present disclosure, there is provided a storage medium. In the aforesaid solution and in the embodiment, the storage medium is further configured to store program codes for performing steps S1 to S2.

In S1, a sending terminal determines a transmission parameter set corresponding to a transmission resource region, and transmission parameters in the transmission parameter set include at least one of a resource aggregation granularity parameter, a precoding granularity parameter, and a resource mapping parameter.

In S2, the sending terminal executes transmission in a corresponding transmission resource region according to the transmission parameters.

In the aforesaid solution, the storage medium is further configured to store program codes for performing steps S3 to S4.

In S3, a receiving terminal determines the transmission resource region, and transmission resources include a time domain resource, a frequency domain resource, an antenna resource, a beam resource, and a code resource.

In S4, the receiving terminal determines a transmission parameter set corresponding to the transmission resource region, and transmission parameters in the transmission parameter set include at least one of a resource aggregation granularity parameter and a precoding granularity parameter.

In the aforesaid solution and in the embodiment, the storage medium may include, but is not limited to, a medium capable of storing a program code, such as a U disk, a read-only memory (ROM), a random access memory (RAM), a removable hard disk, a magnetic disk, or an optical disk, and the like.

In the aforesaid solution and in the embodiment, the processor implements the aforesaid steps S1 and S2 according to the program code stored in the storage medium.

In the aforesaid solution and in the embodiment, the processor implements the aforesaid steps S3 and S4 according to the program code stored in the storage medium.

In the aforesaid solution, for specific examples in the embodiment, reference may be made to the examples described in the aforesaid embodiments and optional embodiments, and repeated descriptions are omitted herein.

Those skilled in the art may understand that the above modules and steps in the embodiments of the present disclosure can be realized using a general-purpose computing device, can be integrated in a single computing device or distributed on a network that consists of a plurality of computing devices; and alternatively, they can be realized using the executable program code of the computing device, so that they can be stored in a storage device and executed by the computing device, and in some cases, can perform the shown or described steps in a sequence other than herein, or they are made into different integrated circuit modules respectively, or a plurality of modules or steps thereof are made into a single integrated circuit module, thus to be realized. In this way, the present disclosure is not limited to any particular hardware and software combination.

In the embodiment of the present disclosure, there is further provided a storage medium in which a computer-executable instruction is stored, and the computer-executable instruction is used to implement flowing steps: determining a transmission parameter set corresponding to a transmission resource region, wherein transmission parameters in the transmission parameter set include at least one of a resource aggregation granularity parameter, a precoding granularity parameter, and a resource mapping parameter; and executing transmission in a corresponding transmission resource region according to the transmission parameters.

When the computer program is executed by the processor, the processor further implements a step of determining a transmission resource region, and transmission resources include at least one of a time domain resource, a frequency domain resource, an antenna resource, a beam resource, and a code resource, a quantity of the transmission resource region is N, and N is greater than or equal to 1.

When the computer program is executed by the processor, the processor further implements a step of sending setting signaling of transmission to a receiving terminal.

When the computer program is executed by the processor, the processor further implements a step of setting the resource aggregation granularity parameter/precoding binding parameter respectively by one or more of: at least two DCI types, at least two DCI overhead sizes, at least two transmission technologies, at least two pilot port groups, at least two channels/signals, at least two CB/CBGs, at least two TBs/CWs, at least two service types, at least two waveforms, at least two beam types, at least two beam groups, at least two time domain symbol groups/slot groups/subframe groups, at least two antennas, at least two MCSs, at least two resource mapping methods, and at least two HARQ related parameters.

When the computer program is executed by the processor, the processor further implements a step of: determining information-to-resource mapping setting respectively by at least one of: at least two layers, at least two layer numbers, at least two CWs, at least two MCSs, at least two DMRS settings, at least two PTRS settings, at least two numerologies, at least two waveforms, at least two slot types, at least two transmission schemes, at least two DCI types, at least two traffic types, at least two CB/CBG settings, at least two transmission settings, at least two beams, at least two beam numbers, at least two reception methods, at least two precoding binding granularities/resource aggregation granularities, at least two HARQ related parameters, and at least two multiple access methods/multiplexing methods.

In an embodiment of the present disclosure, there is further provided a storage medium in which a computer-executable instruction is stored, and the computer-executable instruction is used to implement following steps: determining a transmission resource region, wherein transmission resources include a time domain resource, a frequency domain resource, an antenna resource, a beam resource, and a code resource; and determining a transmission parameter set corresponding to the transmission resource region, wherein transmission parameters in the transmission parameter set include at least one of a resource aggregation granularity parameter, a precoding granularity parameter, a resource mapping parameter, and a CB/CBG.

When the computer program is executed by the processor, the processor further implements a step of executing transmission in the transmission resource region according to the transmission parameter set.

When the computer program is executed by the processor, the processor further implements a step of: setting the resource aggregation granularity parameter/precoding binding parameter respectively by one or more of: a DCI type, a transmission technology, a pilot port group, a channel/signal type, a CB/CBG setting, a service type, a waveform, a beam type, a beam group, a time domain symbol group/slot group/subframe group, an antenna group, an MCS group, a resource allocation granularity, a pilot pattern, an antenna/port number, an HARQ related parameter, a receiving method, a multiple access method, a multiplexing method, and a QCL setting.

When the computer program is executed by the processor, the processor further implements steps of: determining a precoding granularity parameter of a second channel/signal according to a precoding granularity parameter of a first channel/signal; determining a precoding granularity parameter of uplink data/DMRS according to a precoding granularity parameter of SRS and a precoding granularity parameter of uplink control; determining a precoding granularity parameter of uplink control/DMRS according to the precoding granularity parameter of SRS and a precoding granularity parameter of uplink data; and determining a precoding granularity parameter of downlink data/downlink control/DMRS according to a precoding granularity parameter of CSI-RS.

When the computer program is executed by the processor, the processor further implements steps of: determining a precoding granularity parameter of an uplink channel/signal according to a precoding granularity parameter of a downlink channel/signal; determining a precoding granularity parameter of SRS according to a precoding granularity parameter of CSI-RS; and determining a precoding granularity parameter of UL DMRS according to a precoding granularity parameter of CSI-RS.

When the computer program is executed by the processor, the processor further implements a step of determining a precoding granularity parameter of a downlink channel/signal according to a precoding granularity parameter of an uplink channel/signal.

When the computer-executable instructions are executed by the processor, the processor further implements a step of determining a precoding granularity parameter of a downlink channel/signal according to a precoding granularity parameter of an uplink channel/signal.

When the computer program is executed by the processor, the processor further implements steps of: determining the time window parameter according to a type of the transmission channel/signal; or determining the time window parameter according to a beam group to which the transmission belongs; or determining the time window parameter according to the transmission resource region.

The above description is only the embodiments of the present disclosure, and is not intended to limit the present disclosure. For those skilled in the art, various modifications and changes can be made to the present disclosure. Any modification, equivalent replacement, improvement, etc. made according to the spirit and principle of the present disclosure shall be regarded as within the protection scope of the disclosure.

### INDUSTRIAL APPLICABILITY

In embodiments of the present disclosure, a sending terminal determines a transmission parameter set corresponding to a transmission resource region, and transmission parameters in the transmission parameter set include at least one of a resource aggregation granularity parameter, a precoding granularity parameter, and a resource mapping parameter; and the sending terminal then executes transmission in a corresponding transmission resource region according to the transmission parameters. A receiving terminal determines a transmission resource region, and transmission resources include a time domain resource, a frequency domain resource, an antenna resource, a beam resource, and a code resource; and the receiving terminal then determines a transmission parameter set corresponding to the transmission resource region, and transmission parameters in the transmission parameter set includes at least one of a resource aggregation granularity parameter, a precoding granularity parameter, a resource mapping parameter, and a CB/CBG. In this way, the sending terminal may execute the transmission in the corresponding transmission region according to the transmission parameters, which enables the sending terminal to set the transmission parameters more flexibly, thereby solving the problem that settings related to the transmission have a low flexibility in related art.

1. A method for transmission, comprising:
determining, by a sending terminal, a transmission parameter set corresponding to a transmission resource region, wherein transmission parameters in the transmission parameter set comprise at least one of a resource aggregation granularity parameter, a precoding granularity parameter, and a resource mapping parameter; and
executing, by the sending terminal, transmission in a corresponding transmission resource region according to the transmission parameters.

2. The method according to claim 1, further comprising:
determining, by the sending terminal, the transmission resource region, wherein transmission resources comprise at least one of a time domain resource, a frequency domain resource, an antenna resource, a beam resource, and a code resource, a quantity of the transmission resource region is N, and N is greater than or equal to 1.

3. The method according to claim 1, further comprising:
sending, by the sending terminal, a setting signaling of transmission to a receiving terminal.

4. The method according to claim 1, wherein the resource aggregation granularity parameter/precoding binding parameter is set respectively by one or more of:
at least two downlink control information (DCI) types, at least two DCI overhead sizes, at least two transmission technologies, at least two pilot port groups, at least two channels/signals, at least two code blocks (CBs)/code block groups (CBGs), at least two transmission blocks (TBs)/code words (CWs), at least two service types, at least two waveforms, at least two beam types, at least two beam groups, at least two time domain symbol groups/slot groups/subframe groups, at least two antennas, at least two modulation and coding schemes (MCSs), at least two resource mapping methods, at least two receiving methods, and at least two hybrid automatic repeat request (HARD) related parameters.

5. The method according to claim 1, wherein
the resource aggregation granularity parameter/precoding granularity parameter comprises at least one time window parameter, wherein the time window parameter is used to determine a resource aggregation granularity/precoding binding granularity.

6. The method according to claim 5, wherein setting the time window parameter comprises:
setting the time window parameter for at least two types of channels/signals, respectively; or
setting the time window parameter for at least two beam groups, respectively; or
setting the time window parameter for at least two transmission resource regions, respectively.

7. The method according to claim 1, wherein an information-to-resource mapping setting is determined respectively by at least one of:
at least two layers, at least two layer numbers, at least two CWs, at least two MCSs, at least two demodulation reference signal (DMRS) settings, at least two phase tracking reference signal (PTRS) settings, at least two numerology settings, at least two waveforms, at least two slot types, at least two transmission schemes, at least two DCI types, at least two traffic types, at least two CB/CBG settings, at least two transmission settings, at least two beams, at least two beam numbers, at least two receiving methods, at least two precoding binding granularities/resource aggregation granularities, at least two HARQ related parameters, and at least two multiple access methods/multiplexing methods.

9. A method for setting transmission, comprising:
determining, by a receiving terminal, a transmission resource region, wherein transmission resources comprise a time domain resource, a frequency domain resource, an antenna resource, a beam resource, and a code resource; and
determining, by the receiving terminal, a transmission parameter set corresponding to the transmission resource region, wherein transmission parameters in the transmission parameter set comprise at least one of a resource aggregation granularity parameter, a precoding granularity parameter, a resource mapping parameter, and a code block (CB)/code block group (CBG).

10. The method according to claim 9, further comprising:
executing, by the receiving terminal, transmission in the transmission resource region according to the transmission parameter set.

11. The method according to claim 9, wherein the resource aggregation granularity parameter/precoding binding parameter is determined respectively by one or more of:
a downlink control information (DCI) type, a transmission technology, a pilot port group, a channel/signal type, a CB/CBG setting, a service type, a waveform, a beam type, a beam group, a time domain symbol group/slot group/subframe group, an antenna group, a modulation and coding scheme (MCS) group, a resource allocation granularity, a pilot pattern, an antenna/port number, an hybrid automatic repeat request (HARD) related parameter, a receiving method, a multiple access method, a multiplexing method, and a quasi-co-location (QCL) setting.

12. The method according to claim 9, wherein
the receiving terminal determines a precoding granularity parameter of a second channel/signal according to a precoding granularity parameter of a first channel/signal;
the receiving terminal determines a precoding granularity parameter of uplink data/demodulation reference signal (DMRS) according to a precoding granularity parameter of a sounding reference signal (SRS) and a precoding granularity parameter of uplink control;
the receiving terminal determines a precoding granularity parameter of uplink control/DMRS according to the precoding granularity parameter of SRS and a precoding granularity parameter of uplink data; and
the receiving terminal determines a precoding granularity parameter of downlink data/downlink control/DMRS according to a precoding granularity parameter of a channel state information-reference signal (CSI-RS).

13. The method according to claim 9, wherein
the receiving terminal determines a precoding granularity parameter of an uplink channel/signal according to a precoding granularity parameter of a downlink channel/signal;
the receiving terminal determines a precoding granularity parameter of SRS according to a precoding granularity parameter of CSI-RS; and
the receiving terminal determines a precoding granularity parameter of uplink (UL) DMRS according to a precoding granularity parameter of CSI-RS.

14. The method according to claim 9, wherein
the receiving terminal determines a precoding granularity parameter of a downlink channel/signal according to a precoding granularity parameter of an uplink channel/signal.

16. The method according to claim 9, wherein
the resource aggregation granularity parameter/precoding granularity parameter comprises at least one time window parameter, wherein the time window parameter is used to determine a resource aggregation granularity/precoding binding granularity.

18. The method according to claim 9, wherein an information-to-resource mapping setting is determined respectively by at least one of:
a layer/layer group, a layer number, a MCS, a DMRS pattern, a phase tracking reference signal (PTRS) pattern, a numerology, a waveform, a slot type, a transmission scheme, a DCI type, a traffic type, a CB/CBG setting, a transmission setting, a beam, a beam number, a receiving method, a precoding binding granularity/resource aggregation granularity, an HARQ related parameter, a multiple access method, a multiplexing method, an A/N setting, a code word (CW)/transmission blocks (TB) setting, and a QCL setting.

20. The method according to claim 9, wherein the transmission parameters further comprise setting information of CB/CBG, and a terminal determines settings of the CB and CBG according to following information:
a capability of a receiving node, a setting of layer numbers, a DCI type, a transmission technology, a demodulation reference signal setting, a resource allocation granularity, a multiple access method, a multiplexing method, an MCS setting, and a QCL setting.

25. A base station, comprising:
a processor and a memory storing instructions executable to the processor, which, when executing the instructions, implements the method for transmission according to claim 1.

27. A terminal, comprising:
a processor and a memory storing instructions executable to the processor, which, when executing the instructions, implements the method for setting transmission according to claim 9.

29. A storage medium in which computer-executable instructions are stored, wherein when the computer-executable instructions are executed by a processor, the processor implements the method for transmission according to claim 1.

30. A storage medium in which computer-executable instructions are stored, wherein when the computer-executable instructions are executed by a processor, the processor implements the method for setting transmission according to claim 9.
